(19) United States
(12) Patent Application Publication
(10) Pub. No.: US 2011/0129613 A1
(43) Pub. Date: Jun. 2, 2011

(54) RELEASE SHEET AND PRODUCTION PROCESS FOR THE SAME

(75) Inventors: Sou MIYATA, Chiba (JP); Takuo Nishida, Saitama (JP); Toshio Sugisaki, Saitama (JP)

(73) Assignee: LINTEC CORPORATION, Itabashi-ku (JP)

(21) Appl. No.: 13/016,160

(22) Filed: Jan. 28, 2011

Related U.S. Application Data
(62) Division of application No. 11/683,575, filed on Mar. 8, 2007.

(30) Foreign Application Priority Data
Mar. 31, 2006 (JP) 2006-097137

(51) Int. Cl. C08F 2/50

(52) U.S. Cl. 427/508

(57) ABSTRACT

A process for making a release sheet which is non-silicone based and has good releasability from a pressure sensitive adhesive layer and which makes it possible to form a release agent layer at low temperature, having solvent resistance. The process comprises coating a substrate film with a release agent liquid, drying, and curing, to give a release agent layer, wherein the release agent layer is a cured layer obtained by irradiating a diene base polymer containing an intermolecular cleavage photopolymerization initiator with an active energy beam.

### BACKGROUND OF THE INVENTION

1. Field of the Invention

The present invention relates to a release sheet and a production process for the same. More specifically, it relates to a release sheet suitably used in applications in which silicone transferred to a pressure sensitive adhesive face comes into a problem, such as adhesion of electronic parts, uses in labels and pressure sensitive adhesive sheets for processing semiconductor wafer and a production process for the same.

2. Description of the Related Art

In recent years, a pressure sensitive adhesive sheet is used in various forms at various stages of production steps for precision electronic devices such as ceramic condensers, hard disc drives, semiconductor equipments and the like.

In a pressure sensitive adhesive sheet used at such production steps for precision electronic devices, a silicone based pressure sensitive adhesive is likely to cause troubles in electronic parts due to a low molecular silicone compound contained therein, and therefore non-silicone based pressure sensitive adhesives, for example, acryl base pressure sensitive adhesives, polyester base pressure sensitive adhesives, urethane base pressure sensitive adhesives and the like are usually used.

In the above non-silicone based pressure sensitive adhesives, a release sheet comprising a releasing layer provided on a substrate is laminated thereon in order to protect a pressure sensitive adhesive layer until use.

As described above, a silicone based release agent is principally used at present for a pressure sensitive adhesive sheet used in the electronic material field. If a pressure sensitive adhesive sheet is stuck on a silicone based release agent, transfer of silicone onto a pressure sensitive adhesive face is brought about in no small quantities. Use of the above pressure sensitive adhesive sheet as, for example, a label for hard discs (HDD) brings about the problem that a small amount of silicone transferred onto a pressure sensitive adhesive face causes failures in the discs described above.

Accordingly, it is investigated to reduce transfer of silicone from a release sheet. Further, alkid base resins (refer to, for example, a patent document 1), long-chain alkyl base resins (refer to, for example, a patent document 2) and polyolefin resins (refer to, for example, a patent document 3) which are known as non-silicon release agents are tried to use for a release agent layer.

However, when the above resins are used for a release agent layer, brought about is the problem that because of a high releasing strength required for releasing from a pressure sensitive adhesive layer, the pressure sensitive adhesive layer is not released from the release agent layer in a certain case.

Further, in the electronic material field, formation of a release agent layer at low temperature because of matters related to a substrate and a durability thereof against organic solvents are required in many cases.

Patent document 1: Japanese Patent Application Laid-Open No. 49685/1982

Patent+document 2: Japanese Patent Application Laid-Open No. 249757/2002

Patent document 3: Japanese Patent Application Laid-Open No. 59515/2002

### SUMMARY OF THE INVENTION

In light of the situation described above, an object of the present invention is to provide a release sheet which is a non-silicone based and has a good releasability from a pressure sensitive adhesive layer and which makes it possible to form a release agent layer at low temperature and has a solvent resistance.

Intensive researches repeated by the present inventors in order to achieve the object described above have resulted in finding that a release sheet having the characteristics described above can be obtained by coating a release agent liquid containing an intermolecular cleavage type photopolymerization initiator and a diene base polymer on a substrate film, drying it and then curing it by irradiating with an active energy beam to form a release agent layer. The present invention has been completed based on the above knowledge.

That is, the present invention provides the following release sheet and production process for the same.

(1) A release sheet comprising a substrate film and a release agent layer, wherein the release agent layer is a cured layer obtained by irradiating a diene base polymer containing an intermolecular cleavage type photopolymerization initiator with an active energy beam.
(2) The release sheet as claimed in the above item (1), wherein the active energy beam is a UV ray.
(3) The release sheet as claimed in the above item (1) or (2), wherein a proportion of the intermolecular cleavage type photopolymerization initiator is 0.01 to 10 mass parts per 100 mass parts of the diene base polymer.
(4) The release sheet as claimed in any one of the above items (1) to (3), wherein the release agent layer has a thickness of 0.02 to 5 μm.
(5) A production process for a release sheet, comprising coating a release agent liquid containing an intermolecular cleavage type photopolymerization initiator and a diene base polymer on a substrate film, drying it and then curing it by irradiating with an active energy beam to thereby form a release agent layer.

The release sheet of the present invention is free of silicone transferred onto a pressure sensitive adhesive layer face and provided with an excellent releasability by assuming the constitution described above. Further, in the production process for a release sheet according to the present invention, a releasing layer can be formed at low temperature, and therefore the releasing layer can be formed on a substrate which is short of a heat resistance. Further, the release sheet of the present invention has the characteristic that it is excellent in a durability to organic solvents such as toluene, ethyl acetate and methyl ethyl ketone (MEK), and it can meet coating by transferring of a pressure sensitive adhesive. Accordingly, the release sheet of the present invention can suitably be used in applications in which silicone transferred onto a pressure sensitive adhesive face comes into a problem, such as use for adhesion or label of electronic parts, and pressure sensitive adhesive sheets for processing semiconductor wafer.

In the release sheet of the present invention, a release agent layer comprising a cured layer obtained by irradiating a diene base polymer containing an intermolecular cleavage type photopolymerization initiator with an active energy beam is provided on a substrate film.

The substrate film in the release sheet of the present invention shall not specifically be restricted, and a substrate film suitably selected from substrate films which have so far been publicly known as substrate films for a release sheet can be used. The above substrate film includes, for example, paper substrate films such as glassine paper, coated paper, cast-coated paper, lint-free paper and the like, laminated papers prepared by laminating thermoplastic resins such as polyethylene and the like on the above paper substrate films, polyester films of polyethylene terephthalate, polybutylene terephthalate, polyethylene naphthalate and the like, polyolefin films of polyethylene, polypropylene, polymethylpentene and the like, plastic films such as a polycarbonate film, a cellulose acetate base film and the like and laminated sheets comprising the above materials. A thickness of the above substrate films shall not specifically be restricted, and usually it is preferably 10 to 150 μm.

When a plastic film is used as the substrate film, a face of the above plastic film of a side on which a release agent layer is provided can be subjected, if necessary, to physical or chemical treatment such as an oxidation method and a roughening method for the purpose of enhancing an adhesion between the plastic film and the release agent layer. The oxidation method described above includes, for example, corona discharge treatment, chromic acid treatment, flame treatment, hot blast treatment, ozone·UV ray irradiation treatment and the like. The roughening method described above includes, for example, a sand blast method, a solvent treatment method and the like. The above surface treatment methods are suitably selected according to the kind of the substrate, and in general, a corona discharge treatment method is preferably used in terms of an effect and an operationality. Further, it can be subjected as well to primer treatment.

In the release sheet of the present invention, an undercoat layer may be provided between the substrate film and the release agent layer in order to enhance an adhesion and provide the release sheet with specific characteristics.

The release sheet of the present invention comprises the substrate film described above and the release agent layer comprising a cured layer obtained by irradiating a diene base polymer containing an intermolecular cleavage type photopolymerization initiator with an active energy beam. Diene base homopolymers such as polybutadiene, polyisoprene, polychloroprene and the like are used as the diene base polymer used for the release agent layer from the viewpoint that relatively light releasing is obtained, and particularly polybutadiene and polyisoprene are suitably used. Further, diene base copolymers such as polystyrene-polybutadiene, polystyrene-polyisoprene and the like may be used.

In the present invention, a radical base intermolecular cleavage type photopolymerization initiator which generates radicals by irradiation with an active energy beam is used as the photopolymerization initiator. A radical base polymerization initiator has radical-generating mechanisms of an intermolecular cleavage type and a hydrogen-drawing type, and the intermolecular cleavage type is used in terms of a curing efficiency of the diene base polymer. That is, the diene base polymer can be three-dimensionally cross-liked by radical polymerization, and it is effective for obtaining the release agent layer having a solvent resistance.

The intermolecular cleavage type photopolymerization initiator includes 2,2-dimethoxy-1,2-diphenylethane-1-one, 1-hydroxy-cyclohexyl-phenyl-ketone, 2-hydroxy-2-methyl-1-phenyl-propane-1-one, 1-[4-(2-hydroxyethoxy)phenyl]-2-hydroxy-2-methyl-1-propane-1-one, 2-methyl-1-[4-(methylthio)phenyl]-2-morpholinopropane-1-one, 2-benzyl-2-dimethylamino-1-(4-morpholinophenyl)butanone-1, bis(2,4,6-trimethylbenzoyl)phenylphosphine oxide, oligo[2-hydroxy-2-methyl]-1-[4-(1-methylvinyl)phenyl]propanone and the like.

A proportion of the intermolecular cleavage type photopolymerization initiator is preferably 0.01 to 10 mass parts, more preferably 0.05 to 1.5 mass part per 100 mass parts of the diene base polymer. A satisfactory curing property of the release agent is obtained by setting the proportion to 0.01 mass part or more. On the other hand, setting it to 10 mass parts or less makes it possible to avoid such influence to the releasability that releasing becomes heavier.

When the release agent layer is formed in the present invention, an antioxidant is preferably added. The antioxidant shall not specifically be restricted, and any of publicly known phosphite base antioxidants, organic sulfur base antioxidants, hindered phenol base antioxidants and the like can be used.

In the present invention, the release agent layer can be formed by coating and drying a release agent liquid prepared by dissolving the materials described above in an organic solvent and then irradiating it with an active energy beam.

Solvents suitably selected from publicly known solvents having a good solubility to the diene base polymer can be used as the solvent used in the above case. The above solvents include, for example, toluene, xylene, methanol, ethanol, isobutanol, n-butanol, acetone, methyl ethyl ketone, tetrahydrofuran and the like. They may be used alone or in combination of two or more kinds thereof.

The release agent liquid is preferably prepared using the above solvents in terms of convenience in coating so that a solid matter concentration falls in a range of 0.1 to 15 mass %.

The release agent liquid can be coated on the substrate film described above by coating methods which have so far been publicly known, for example, a bar coating method, a reverse roll coating method, a knife coating method, a roll knife coating method, a gravure coating method, an air doctor coating method, a doctor blade coating method and the like.

In the present invention, the release agent layer can be formed, as described above, by coating the release agent liquid on the substrate film described above, drying it and then irradiating it with an active energy beam. The active energy beam used includes, for example, an electron beam and a UV ray, and a UV ray is suited in terms of an absorption wavelength of the intermolecular cleavage type photopolymerization initiator used and damages such as deterioration given to the substrate.

A high pressure mercury lamp, a metal halide lamp, a high power metal halide lamp, an electrodeless lamp and the like which have so far been publicly known can be used as a UV ray lamp used for irradiating with a UV ray, and the electrodeless lamp is most suited in terms of a curing property of the diene base polymer.

A dose of a UV ray falls preferably in a range of 10 to 150 mJ/cm² from the viewpoints of obtaining a high adhesion between the substrate of the release sheet and the release agent and obtaining light release.

A thickness of the release agent layer is preferably 0.02 to 5.0 μm, more preferably 0.05 to 1.5 μm in the state that the release agent liquid is coated on the substrate film, dried and then cured. Setting the thickness to 0.02 μm or more provides the satisfactory releasability, and setting it to 5.0 μm or less makes it unlikely to bring about troubles such as blocking between the back face of the release sheet and the release agent layer.

The pressure sensitive adhesive applied to the release sheet of the present invention shall not specifically be restricted, and it can suitably be selected from pressure sensitive adhesives which have so far been publicly known, such as acryl base pressure sensitive adhesives, polyester base pressure sensitive adhesives, urethane base pressure sensitive adhesives and the like.

### EXAMPLES

Next, the present invention shall be explained in further details with reference to examples, but the present invention shall by no means be restricted by these examples.

In the examples and the comparative examples, measurements of a releasing strength and a silicone transfer amount and evaluation of a solvent resistance were carried out by the following methods.

### (1) Measurement of Releasing Strength:

A pressure sensitive adhesive sheet (31B Tape manufactured by Nitto Denko Corporation) was stuck on the releasing layer, and the releasing strength was measured after left standing for 30 minutes under the conditions of a temperature of 23° C. and a relative humidity of 50% (180° peel, a releasing speed: 0.3 m/minute).

### (2) Measurement of Silicone Transfer Amount:

In a pressure sensitive adhesive layer face of a pressure sensitive adhesive sheet from which the release sheet was released, an atomic ratio (atomic %) of silicone present on the surface thereof was measured on the following conditions by X ray photoelectron spectroscopy (XPS).

Measuring equipment: Quantera SXM manufactured by ULVAC-PHI, Inc.
X ray source: AlKα (1486.6 eV)
Output angle: 46 degrees
Measured elements: silicon (Si) and carbon (C)

A value of Si/(Si+C) was multiplied by 100 to show the Si amount by “atomic %”.

### (3) Evaluation of Solvent Resistance:

The release agent layer of the release sheet was rubbed ten times with three kinds of rages impregnated with methyl ethyl ketone (MEK), toluene or ethyl acetate, and then the pressure sensitive adhesive sheet (31B Tape manufactured by Nitto Denko Corporation) was stuck thereon. The releasing strength described above was measured, and a change in a releasability on the treated face in releasing was confirmed and evaluated on the following criteria:

◯: little change was observed in the releasing strength.
X: changing to heavier releasing was occurred.

The release sheets having a releasing strength exceeding 1000 mN/20 mm bring about changing to heavier releasing and can not substantially be used.

### Example 1

1-Hydroxy-cyclohexyl-phenyl-ketone (trade name: Irgacure 184, manufactured by Ciba Geigy Co., Ltd.) 0.05 mass part was added as an intermolecular cleavage type photopolymerization initiator to a diene base polymer (polybutadiene, trade name: Nipol 1241, manufactured by Zeon Corporation) 100 mass parts, and the mixture was diluted with toluene so that a solid matter concentration was about 0.5 mass %. This release agent solution was applied on one face of a polyethylene terephthalate film (hereinafter referred to as a PET film, trade name: PET 38T-100, manufactured by Mitsubishi Polyester Film Corp.) by means of a Mayer bar, and then the solvent was dried at 90° C. for about one minute. The film was irradiated (about 100 mJ/cm²) with a UV ray by means of an electrodeless lamp to cure a release agent layer, whereby a release sheet having a film thickness of 0.1 μm was obtained. Results obtained by measuring the releasing strength and the silicone transfer amount and a result obtained by evaluating the solvent resistance are shown in Table 1.

### Example 2

A release sheet was obtained in the same manner as in Example 1, except that an addition amount of the intermolecular cleavage type photopolymerization initiator was changed to 1.0 mass part. Results obtained by measuring the releasing strength and the silicone transfer amount and a result obtained by evaluating the solvent resistance are shown in Table 1.

### Example 3

A release sheet was obtained in the same manner as in Example 1, except that a film thickness of the release agent layer was changed to about 1.0 μm Results obtained by measuring the releasing strength and the silicone transfer amount and evaluating the solvent resistance are shown in Table 1.

### Example 4

A release sheet was obtained in the same manner as in Example 1, except that a diene base polymer (polyisoprene, trade name: LIR30, manufactured by Kuraray Co., Ltd.) was used. Results obtained by measuring the releasing strength and the silicone transfer amount and a result obtained by evaluating the solvent resistance are shown in Table 1.

### Comparative Example 1

A release sheet was obtained in the same manner as in Example 1, except that the intermolecular cleavage type photopolymerization initiator was not added to the release agent solution. Results obtained by measuring the releasing strength and the silicone transfer amount and a result obtained by evaluating the solvent resistance are shown in Table 1.

### Comparative Example 2

An addition reaction type silicone resin (trade name: KS-847H, manufactured by Shin-Etsu Chemical Co., Ltd.) 100 mass parts and a chloroplatinic acid base cross-linking agent (trade name: CAT-PL-50T, manufactured by Shin-Etsu Chemical Co., Ltd.) 1.0 mass part were diluted with toluene so that a solid matter concentration was about 1.1 mass % to prepare a release agent coating liquid. This release agent coating liquid was applied on one face of the PET film (trade name: PET 38T-100, manufactured by Mitsubishi Polyester Film Corp.) by means of a Mayer bar, and then it was dried at 130° C. for about one minute to obtain a release sheet. Results obtained by measuring the releasing strength and the silicone transfer amount and a result obtained by evaluating the solvent resistance are shown in Table 1.

### Comparative Example 3

A release sheet was obtained in the same manner as in Example 1, except that benzophenone (manufactured by Tokyo Chemical Industry Co., Ltd.) which was a hydrogen-drawing type polymerization initiator was added in place of the intermolecular cleavage type photopolymerization initiator. Results obtained by measuring the releasing strength and the silicone transfer amount and a result obtained by evaluating the solvent resistance are shown in Table 1.

TABLE 1

| | | | | | | Comparative | | |
|---|---|---|---|---|---|---|---|---|
| | | Example | | | | Example | | |
| | | 1 | 2 | 3 | 4 | 1 | 2 | 3 |
| (Release sheet) | | | | | | | | |
| Resin (mass part) | | | | | | | | |
| Diene base polymer (Nipol 1241) | | 100 | 100 | 100 | | 100 | | 100 |
| Diene base polymer (LIR30) | | | | | 100 | | | |
| Silicone resin (KS-847H) | | | | | | | 100 | |
| Polystearyl acrylate | | | | | | | | |
| Additives (mass part) | | | | | | | | |
| Photopolymerization initiator | | 0.05 | 1.0 | 0.05 | 0.05 | | | |
| (intermolecular cleavage type) | | | | | | | | |
| Cross-linking agent (CAT-PL-50T) | | | | | | | 1.0 | |
| Photopolymerization initiator (hydrogen- | | | | | | | | 0.05 |
| drawing type) | | | | | | | | |
| Thickness of release agent layer (μm) | | 0.1 | 0.1 | 1.0 | 0.1 | 0.1 | 0.1 | 0.1 |
| (Measurement and evaluation results) | | | | | | | | |
| (1) Releasing strength (mN/20 mm) | | 90 | 120 | 100 | 140 | 100 | 50 | 110 |
| (2) Silicone transfer amount (atomic %) | | 0.0 | 0.0 | 0.0 | 0.0 | 0.0 | 2.1 | 0.0 |
| (3) Solvent resistance (releasing | | | | | | | | |
| strength | | | | | | | | |
| after test: mN/20 mm) | | | | | | | | |
| Solvent: | MEK | 90 (◯) | 110 (◯) | 110 (◯) | 140 (◯) | >6000 (X) | 50 (◯) | >6000 (X) |
| | Toluene | 90 (◯) | 120 (◯) | 120 (◯) | 135 (◯) | >6000 (X) | 45 (◯) | >6000 (X) |
| | Ethyl acetate | 90 (◯) | 110 (◯) | 120 (◯) | 160 (◯) | >6000 (X) | 45 (◯) | >6000 (X) |

1-4. (canceled)

5. A process for producing a release sheet, the process comprising:
coating a release agent liquid comprising an intermolecular cleavage photopolymerization initiator and a diene base polymer on a substrate film, to give a coated substrate film;
drying the coated substrate film, to give a dried coated substrate film; and then
curing the dried coated substrate film by irradiating with an active energy beam to thereby form a release agent layer of the release sheet.

6. The process of claim 5, wherein the active energy beam is a UV ray.

7. The process of claim 5, wherein a proportion of the intermolecular cleavage photopolymerization initiator is 0.01 to 10 mass parts per 100 mass parts of the diene base polymer.

8. The process of claim 5, wherein the release agent layer has a thickness of 0.02 to 5 μm.

9. The process of claim 5, wherein the diene base polymer is at least one selected from the group consisting of polybutadiene, polyisoprene, polychloroprene, polystyrene-polybutadiene, and polystyrene-polyisoprene.

10. The process of claim 5, wherein the intermolecular cleavage photopolymerization initiator is at least one selected from the group consisting of 2,2-dimethoxy-1,2-diphenylethane-1-one, 1-hydroxy-cyclohexyl-phenyl-ketone, 2-hydroxy-2-methyl-1-phenyl-propane-1-one, 1-[4-(2-hydroxyethoxy)phenyl]-2-hydroxy-2-methyl-1-propane-1-one, 2-methyl-1-[4-(methylthio)phenyl]-2-morpholinopropane-1-one, 2-benzyl-2-dimethylamino-1-(4-morpholinophenyl)butanone-1, bis(2,4,6-trimethylbenzoyl)phenylphosphine oxide, and oligo[2-hydroxy-2-methyl]-1-[4-(1-methylvinyl)phenyl]propanone.

11. The process of claim 5, wherein a proportion of the intermolecular cleavage photopolymerization initiator is 0.01 to 10 mass parts per 100 mass parts of the diene base polymer.

12. The process of claim 5, wherein a proportion of the intermolecular cleavage photopolymerization initiator is 0.05 to 1.5 mass parts per 100 mass parts of the diene base polymer.

13. The process of claim 5, wherein the release agent liquid further comprises an antioxidant.

14. The process of claim 13, wherein the antioxidant is present in the release agent layer.

15. The process of claim 5, wherein the release agent liquid comprises at least one solvent selected from the group consisting of toluene, xylene, methanol, ethanol, isobutanol, n-butanol, acetone, methyl ethyl ketone, and tetrahydrofuran.

16. The process of claim 15, wherein the release agent liquid comprises the at least one solvent such that a solid matter concentration of the release agent liquid is in a range of 0.1 to 15 mass %.

17. The process of claim 5, wherein the coating is carried out by bar coating, reverse roll coating, knife coating, roll knife coating, gravure coating, air doctor coating, or doctor blade coating.

18. The process of claim 5, wherein the curing is carried out by dose of UV in a range of 10 to 150 mJ/cm².

19. The process of claim 5, wherein the release agent layer has a thickness of 0.05 to 1.5 μm.

20. The process of claim 5, wherein the release sheet maintains a releasing strength after a treatment with an organic solvent in a range of 91.6% to 114.3% of the releasing strength before the treatment with an organic solvent.

21. The process of claim 20, wherein the organic solvent is toluene.

22. The process of claim 20, wherein the organic solvent is ethyl acetate.

23. The process of claim 20, wherein the organic solvent is methyl ethyl ketone.

24. The process of claim 5, wherein the release sheet has a 0 atomic % silicon atom transfer
